(19) United States
(12) Patent Application Publication
(10) Pub. No.: US 2004/0130989 A1
(43) Pub. Date: Jul. 8, 2004

(54) Optical head device using aberration correction device and disk drive unit

(76) Inventors: Gakuji Hashimoto, Saitama (JP); Kenji Yamamoto, Kanagawa (JP)

Correspondence Address: Ronald P Kananen, Rader Fishman & Grauer, The Lion Building Suite 501, 1233 20th Street NW, Washington, DC, 20036, US

(21) Appl. No.: 10/471,094

(22) PCT Filed: Jan. 30, 2002
(86) PCT No.: PCT/JP03/00939

(30) Foreign Application Priority Data
Feb. 6, 2002 (JP) 2002-29433

(51) Int. Cl. G11B 7/00

(52) U.S. Cl. 369/53.19; 369/44.16

(57) ABSTRACT

An optical head and a disk drive reduce the weight of a moving section of the optical head including an objective lens, and achieve more precise aberration correction by independently driving the objective lens and an aberration correcting device. An optical head (3) that constitutes a disk drive (1) is provided with an aberration correcting device (8) for an optical system including an objective lens (6). A first driving means (7) for driving the objective lens (6) and a second driving means (9) for driving the aberration correcting device (8) or a moving section including the device and components (10) of the optical system are provided. The misalignment between the objective lens (6) and the aberration correcting device (8) is corrected.

### TECHNICAL FIELD

The present invention relates to a technique for reducing aberration due to the misalignment between the optical centers of an objective lens and an aberration correcting device provided in an optical head and a disk drive.

### BACKGROUND ART

Various optical recording media (optical disks), represented by CDs (Compact Disks), have been produced according to the applications. For example, known disks are playback-only disks for music information (CDs), recordable disks for music (MDs), DVDs (Digital Versatile Disks) suitable for recording of large volumes of data such as video information, writable disks suitable for data storage in computers (MOs (Mageneto-Optical) disks), CDs-R (Recordable), and CDs-RW (Rewritable).

These optical disks to be used in accordance with various applications are commonly required to enlarge the storage capacity. Promising measures for the requirement are to shorten the wavelength of a laser light source and to further narrow the beam spot by an objective lens having a high numerical aperture (NA).

In order to enlarge the storage capacity by adopting an optical head using an objective lens with a high NA (e.g., 0.8 or more), the following matters are significant:

Since the depth of focus of the lens is decreased by the high NA, an actuator (a biaxial actuator or biaxial device for driving the objective lens) needs to be sensitive in the focusing direction.

When the recording density is increased by shortening the track pitch on a recording medium, the actuator needs to be sensitive in the tracking direction.

That is, the optical head used for high-density recording optical disks needs a highly sensitive actuator.

In an optical disk system using a lens with a high numerical aperture, since spherical aberration occurs for the following reasons, a device for correcting the aberration is necessary:

(1) The thickness of a cover layer of a recording disk (a transparent protective film close to the laser radiation side) is microscopically nonuniform.

(2) The high-NA objective lens is frequently composed of multiple lenses (e.g., a two-unit structure) in order to ensure a sufficient optical margin (margin in optical design). As a result, an error occurs in the distance between the lenses.

(3) Aberration is caused by the increase of the number of recording layers of the disk.

The problem (3) arises because the distances to the recording films are different. This is equivalent to a great difference in thickness of a transparent protective film (0.1 mm in a DVR) in the case of a single-layer disk. Therefore, a relatively large spherical aberration needs to be corrected in order to perform recording and playback on and from different recording layers.

Spherical-aberration correcting devices using a liquid crystal element or the like have been proposed to correct spherical aberration caused for the above reasons (1) to (3). For example, an optical-aberration correcting device using a liquid crystal element is mounted in a moving section of an optical head including an objective-lens driver to reduce aberration due to the misalignment with an objective lens.

FIG. 12 shows an example of a conventional biaxial actuator that constitutes an optical head (a perspective view, as viewed from a side remote from an objective lens (a side of an unshown light source)).

An actuator a includes a moving section c for supporting an objective lens b, and a fixed section e for supporting the moving section c by four leaf springs d. That is, the leaf springs d extend between the moving section c and the fixed section e to function as suspensions (suspension means).

The moving section c includes a focusing coil f and tracking coils g, and these coils are mounted on a bobbin h of the moving section c. The coils constitute a driving section with a magnetic field section including unshown magnets, and are driven in response to a signal from a control circuit for focus control and tracking control. That is, one-end portions of the leaf springs d are fixedly attached to the fixed section e and are provided with terminals i. The other-end portions of the leaf springs d are provided with terminals j fixed to the bobbin h, and some of the portions are connected to terminal ends of the coils. Accordingly, a driving signal from the unshown circuit is supplied to each coil from any of the terminals i through a leaf spring d, thereby controlling the current to be passed through the coil.

A liquid crystal element k for aberration correction is mounted on a face of the moving section c remote from the objective lens b, and is disposed on the optical axis of an optical system including the objective lens b. A driving signal to the liquid crystal element k is also supplied through the leaf springs d. That is, the leaf springs d having conductivity function as support members for the moving section c, and also function as wiring members for the coils and the liquid crystal element provided in the moving section c.

Such a configuration in which the objective lens b and the liquid crystal element k are mounted in the moving section c can solve the problem of misalignment therebetween.

The above-described conventional configuration has the following problems because the liquid crystal element k for aberration correction is mounted in the moving section c of the biaxial actuator:

(1) Sensitivity of the actuator is decreased by the increase in weight of the moving section.

(2) It is difficult to increase the number of driving signals for the liquid crystal element.

In (2), when driving power or the like is supplied to the liquid crystal element k through the support members (leaf springs d) for elastically supporting the moving section c of the biaxial actuator, the number of driving signals is limited because a driving current also needs to be supplied to the coils (focusing and tracking coils) of the moving section c through the support members. For this reason, it is difficult to increase the number of divisions (number of segments) of the liquid crystal element and to form an ideal pattern for correcting spherical aberration.

Accordingly, an object of the present invention is to independently drive an objective lens and an aberration correcting device in order to reduce the weight of a moving section of an optical head including the objective lens and to achieve more precise aberration correction.

### DISCLOSURE OF INVENTION

In order to overcome the above problems, the present invention includes a first driving means for driving an objective lens, a second driving means for driving an aberration correcting device disposed on the optical path of an optical system, or a moving section including the device and a component of the optical system, and a correction means for correcting the misalignment between the objective lens and the aberration correcting device.

Therefore, since the present invention adopts a configuration in which the objective lens and the aberration correcting device are driven independently, the weight of the moving section including the objective lens can be reduced, and a necessary number of lines for the aberration correcting device can be ensured.

### BRIEF DESCRIPTION OF THE DRAWINGS

FIG. 1 is a schematic view showing the basic configuration according to the present invention.

FIG. 2 is a view showing an example of a configuration of an optical head of the present invention.

FIG. 3 is a view showing another example of a configuration of the optical head of the present invention.

FIG. 4 is a perspective view, showing a structure of a driving mechanism for a liquid crystal element, in conjunction with FIGS. 5 and 6.

FIG. 5 is a plan view, as viewed from the direction of the optical axis.

FIG. 6 is a side view.

FIG. 7 is a perspective view showing another structure of the driving mechanism for the liquid crystal element, in conjunction with FIGS. 8 and 9.

FIG. 8 is a partially cutaway plan view, as viewed from the direction of the optical axis.

FIG. 9 is a side view.

FIG. 10 is an explanatory view of a control system.

FIG. 11 is a block diagram explaining the control system.

FIG. 12 is a perspective view showing an example of a structure of a conventional biaxial actuator.

### BEST MODE FOR CARRYING OUT THE INVENTION

The present invention relates to an optical head using an objective lens, and an aberration correcting device for an optical system including the objective lens, and to a disk drive using the optical head. For example, the present invention is useful in a case in which signal recording and reproduction on and from multiple recording films formed in a recording medium are performed, and in a case in which an optical head uses an objective lens (or a lens unit) having a high numerical aperture (e.g., 0.8 or more). That is, the present invention is suitably applied to a configuration in which a spherical-aberration correcting element, such as a liquid crystal element, is used as an aberration correcting device to correct spherical aberration between the recording films. The present invention is effective in reducing coma aberration due to the misalignment between the objective lens and the aberration correcting device (misalignment of the optical centers).

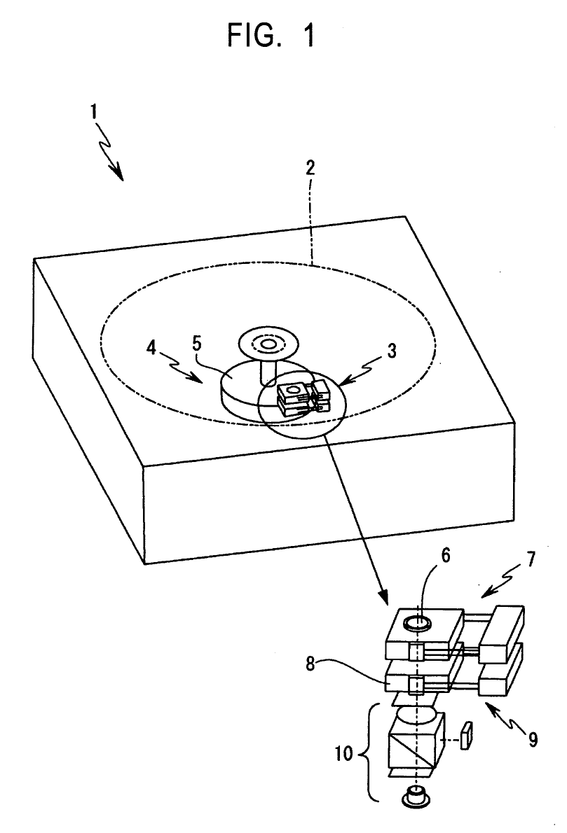

FIG. 1 schematically shows the basic configuration of a disk drive 1, which includes an optical head (or optical pickup) 3 that is driven while opposing a disk-shaped recording medium 2 shown by a two-dot chain line. Examples of the disk-shaped recording medium 2 are the above-described various optical disks, and it does not matter how recording and playback are performed.

A spindle motor 5 is provided as a driving source that constitutes a rotating means 4 for the disk-shaped recording medium 2, and is rotated in a state in which the disk-shaped recording medium 2 is placed on a turntable (or disk table) fixed to a rotation shaft of the motor.

The configuration of the optical head 3 enclosed with a circular frame in FIG. 1 is schematically shown in the lower part of the figure.

In this mode, a first driving means 7 is provided to drive a moving section including an objective lens 6, and a second driving means 9 is also provided to drive an aberration correcting device 8 for an optical system. That is, the objective lens 6 and the aberration correcting device 8 are driven independently.

The optical system including the objective lens 6 has a component section 10 including optical components and devices other than the objective lens and the aberration correcting device 8. While the section and the aberration correcting device 8 may be driven, the figure shows manners in which only the aberration correcting device 8 is driven by the second driving means 9.

That is, the aberration correcting device 8 is driven in the following two manners:

(I) A manner in which only the aberration correcting device disposed on the optical path of the optical system is driven by the second driving mean; and

(II) A manner in which the moving section including the aberration correcting device and (all or some of) the components of the optical system disposed on the optical path of the optical system is driven by the second driving means.

In any manner, the aberration correcting device 8 is driven in a direction orthogonal to the optical axis of the optical system. That is, while the objective lens 6 is driven by the first driving means 7 in a direction along the optical axis (focusing direction) and in a direction orthogonal thereto (tracking direction), the aberration correcting device 8 is driven by the second driving means 9 in the tracking direction orthogonal to the optical axis of the optical system to follow the movement of the objective lens 6 in the tracking direction. Consequently, the misalignment between the objective lens 6 and the aberration correcting device 8 is corrected.

While, for example, a liquid crystal element may be used as the aberration correcting device 8 for spherical aberration, coma aberration, and the like, a beam expander (expanding optical system) and the like are also applicable. For example, in order to correct the misalignment due to the movement of the objective lens by a tracking servo, a moving base of an optical head including a beam expander is driven to follow the objective lens, so that coma aberration (caused by the misalignment between the optical centers of the beam expander and the objective lens) can be reduced.

The present invention is also effective for a structure in which an optical detecting section (including a photoreceptor) is separate as in a separate optical system.

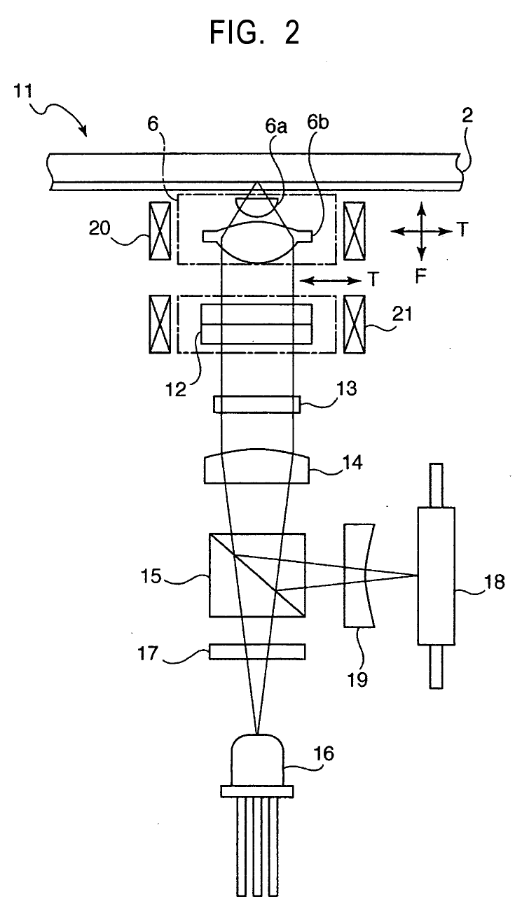

FIG. 2 shows the principal part of a configuration used in the above manner (I).

In an optical system 11, an objective lens 6, a liquid crystal element 12, a quarter-wave plate 13, a collimating lens (or a collimator) 14, and a polarizing beam splitter (PBS) 15 are arranged in that order from a side close to a recording medium 2. In a light emitting system (light transmitting system), a grating (diffraction grating) 17 is interposed between a light source 16 using a laser diode IC or the like, and the polarizing beam splitter 15. In a light receiving system, a lens (so-called multi-lens) 19 is interposed between a light receiving section 18 using a photodiode IC or the like, and the polarizing beam splitter 15.

While the objective lens 6 may be formed of a single lens, it is formed of a lens unit in order to take consideration of the increase of the NA. In this example, the objective lens 6 has a two-unit structure including a first lens 6a close to the recording medium 2, and a second lens 6b having a diameter larger than that of the first lens 6a. These lenses are driven by a biaxial actuator 20 serving as the first driving means (marked with “x” in rectangular frames on both sides of the objective lens 6 in the figure). That is, the biaxial actuator 20 has a focusing coil, as is well known, and the control of driving thereof in the focusing direction parallel to the optical axis of the optical system (so-called focus control) is exerted by a driving current to the coil, as shown by the vertical arrow F in the figure. The control of driving in the tracking direction (a direction perpendicular to the optical axis and parallel to the arranging direction of tracks on the recording medium) (so-called tracking control) is exerted by a driving current to a tracking coil mounted in the biaxial actuator.

The aberration-correcting liquid crystal element 12 is driven by a uniaxial actuator 21 serving as the second driving means (marked with “x” in rectangular frames on both sides of the liquid crystal element 12 in the figure). While the structure of the uniaxial actuator 21 will be described in detail later, the uniaxial actuator 21 is provided to drive the liquid crystal element 12 in one direction (tracking direction orthogonal to the optical axis of the optical system), as shown by the horizontal arrow T in the figure.

Other optical components (13 to 19) that constitute the optical system 11 are fixed in a relative relation to a moving section having the objective lens 6 and a moving section having the liquid crystal element 12. While the components do not have their respective exclusive driving means, the entire head (or pickup) including the optical system is moved relative to the recording medium 2 by an unshown conveyor mechanism (so-called sled mechanism), thereby changing the position of the field of view of the objective lens 6 with respect to the recording medium.

In this example, the liquid crystal element 12 serving as the aberration correcting device for correcting the laser wavefront is driven by the uniaxial actuator 21 in order to reduce aberration due to the misalignment between the liquid crystal element and the objective lens 6. That is, since the moving section of the biaxial actuator 20 is moved in the direction of arrow T in FIG. 2 by tracking servo control, the objective lens 6 is thereby similarly moved. Since this makes the objective lens 6 and the liquid crystal element 12 misaligned, the amount of the misalignment is detected, and position control is exerted on the liquid crystal element 12 by the uniaxial actuator 21 so that the amount reaches zero or the minimum value. Consequently, the liquid crystal element 12 is constantly placed in a proper position in response to the movement of the objective lens 6, and the misalignment therebetween is corrected.

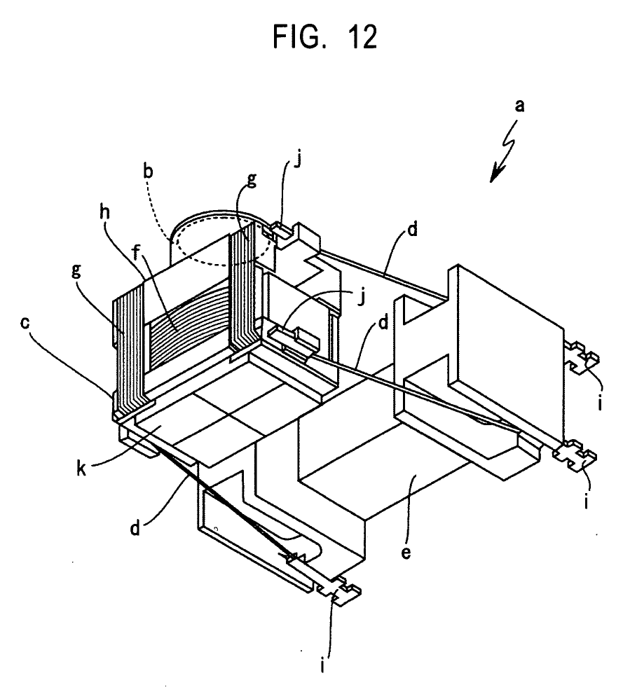

In the conventional configuration shown in FIG. 12, since the objective lens b and the liquid crystal element k are mounted in the moving section c of the biaxial actuator and are driven together, the weight of the moving section is heavy, and it is difficult to ensure acceleration sufficient for control (desensitization). By independently driving the objective lens 6 and the liquid crystal element 12 as in this example, the weight of the moving section including the objective lens 6 can be reduced. That is, by driving the liquid crystal element 12 by the uniaxial actuator 21 provided separately from the biaxial actuator 20 for driving the objective lens 6, the weight of the moving section of the biaxial actuator 20 can be reduced. This makes it possible to ensure acceleration sufficient for control or to enhance sensitivity.

In FIG. 2, light emitted from the light source 16 passes through the grating 17 and the polarizing beam splitter 15 in that order, and is then collimated by the collimating lens 14. Herein, ±1 for first order diffracted light produced by the grating 17 is detected as return light from the recording medium 2 by the light receiving section 18, thereby detecting a tracking error (for example, tracking servo control by a differential push-pull method (DPP)).

The quarter-wave plate 13 is disposed behind the collimating lens 14 to convert linearly polarized light from the laser light source into circularly polarized light.

The light transmitted through the quarter-wave plate 13 enters the liquid crystal element 12, and the light transmitted through the element passes through the two-unit objective lens 6 and is collected on the recording layer of the recording medium 2.

The light reflected by the recording layer retraces the above route as return light. That is, the light passes through the objective lens 6 and the liquid crystal element 12, and is returned from the circularly polarized light into linearly polarized light by the quarter-wave plate 13. In this case, since the direction of polarization tilts by an angle of 90° relative to the light emitted from the light source 16 (light advancing toward the recording medium 2), the return light is reflected by (a bonding surface) of the polarizing beam splitter 15, and the optical path thereof is changed.

While the return light that is being collected by the collimating lens 14 before being reflected by the polarizing beam splitter 15 is reflected by the polarizing beam splitter 15, is collected on (the light receiving surface of) the light receiving section 18 by the lens (multi-lens) 19, and is converted into electrical signals. The lens 19 serves to cause astigmatism by the action based on its shape like a cylindrical lens, and is necessary in a focusing-error detecting method (astigmatism correcting method) utilizing the difference between the imaging positions.

While light emitted from the light source 16 in the optical system is collimated by the collimating lens 14, as described above, since the liquid crystal element 12 is placed on the parallel optical path, it does not need to be moved in the direction parallel to the optical axis. That is, the liquid crystal element 12 (aberration correcting device) is placed on the optical path of the light from the light source 16 after being collimated, and is driven in the direction orthogonal to the optical axis.

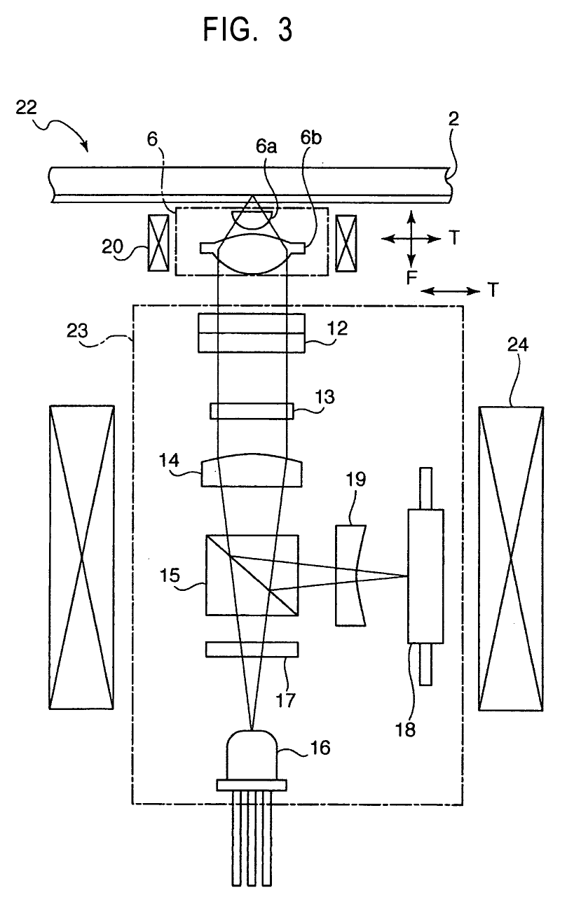

FIG. 3 shows the principal part of a configuration used in the above manner (II). Since an optical system has a configuration similar to that shown in FIG. 2, only differences will be described.

While only the liquid crystal element 12 is moved by the second driving means (uniaxial actuator 21) in the configuration shown in FIG. 2, this example is different in that a liquid crystal element 12 and optical components (13, to 19) are driven together by a second driving means.

That is, the entire section of an optical system 22 including the liquid crystal element 12, a quartz-wave plate 13, a collimating lens 14, a polarizing beam splitter 15, a light source 16, a grating 17, a light receiving section 18, and a lens 19 serves as a moving section 23 (a portion excluding the liquid crystal element 12 corresponds to the above-described component section 10), and is driven by a uniaxial actuator 24 serving as the second driving means (marked with “x” in rectangular frames on both sides of the moving section 23 in the figure). As shown by the horizontal arrow T in the figure, the moving section 23 is moved in one direction (tracking direction orthogonal to the optical axis of the optical system).

In a case in which a beam expander is used instead of the liquid crystal element 12, it is substituted for the element.

In an application to a separate optical system, in FIG. 3, for example, a section including an objective lens 6, a biaxial actuator 20, and an unshown optical-path changing means (rising mirror), and a section including the liquid crystal element 12 and the optical components (13 to 19) are separately provided, or the moving section includes an unshown optical-path changing mirror (rising mirror) and the liquid crystal element 12.

In the above-described manners (I) and (II), in order to increase the numerical aperture of the objective lens (for example, to design the value more than 0.8), a two-unit structure is frequently adopted, as described above. However, this produces an error in the lens distance. Moreover, spherical aberration is caused by the above-described error in the thickness of the cover layer of the disk, and an aberration correcting device using a liquid crystal element or the like is necessary to correct the aberration. When the recording layer has multiple recording layers in order to increase the storage capacity of the disk, it is necessary to adjust the amount of correction of aberration according to the layers.

Since aberration (coma aberration) is caused when misalignment occurs between the objective lens and the liquid crystal element, it is necessary in driving control of the components to minimize relative misalignment therebetween. In particular, when recording and playback are performed on and from a recording medium having a multilayer recording layer, spherical aberration needs to be corrected by a large amount. When coma aberration due to the misalignment between the objective lens and the liquid crystal element increases, it is difficult to achieve sufficient recording performance and reproduction performance. Accordingly, there is a need to remove the misalignment, and the uniaxial actuator 21 or 24 is provided to drive the liquid crystal element 12, as shown in FIGS. 2 and 3.

The liquid crystal element 12 needs to be driven only in the tracking direction of the objective lens 6 in response to the misalignment in the direction, but does not need to be driven in the focusing direction along the optical axis. This is the reason why the uniaxial actuator will do as the driving means for the liquid crystal element 12. As a result, since only a driving mechanism for driving in one direction (direction parallel to the tracking direction) is necessary, the configuration is simplified. The structure of the biaxial actuator for driving the objective lens is basically the same as the conventional structure shown in FIG. 12 except that the liquid crystal element k is not provided. In the present invention, the weight can be reduced because the element does not need to be mounted in the moving section of the biaxial actuator.

In an application to an optical disk capable of high-density recording, the allowable amount of defocus or detrack with respect to the objective lens ranges from approximately several nanometers to several tens of nanometers, and this is quite small. In contrast, the allowable amount of misalignment between the objective lens and the liquid crystal element ranges to the order of approximately several to several tens of microns, and therefore, the design requirement imposed on the sensitivity of the uniaxial actuator is not so strict. Since the liquid crystal element is not formed of a lens assembly, but of a parallel plate, the allowable amount of skew is sufficiently large.

While the optical components are discrete in the examples shown in FIGS. 2 and 3, an integrated optical element and optical unit formed by combining some of the components may be used. For example, in the use of an integrated optical device (e.g., a laser coupler) in which a laser light source, a photoreceptor, and an optical element are mounted on the same substrate, the number of components, including a liquid crystal element and an objective lens, to be provided therein is small, and this is advantageous in reducing the size and weight (in particular, it is preferable in the application to the above manner (II) to integrate the moving section of the uniaxial actuator).

The driving method for the liquid crystal element will now be described.

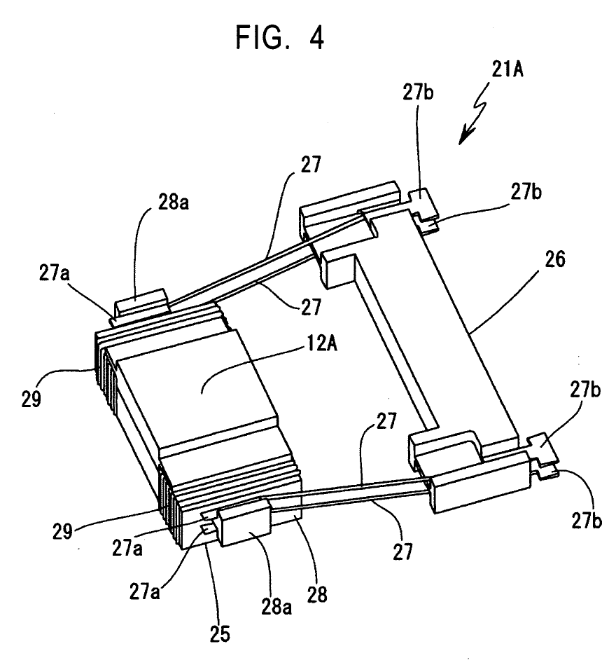

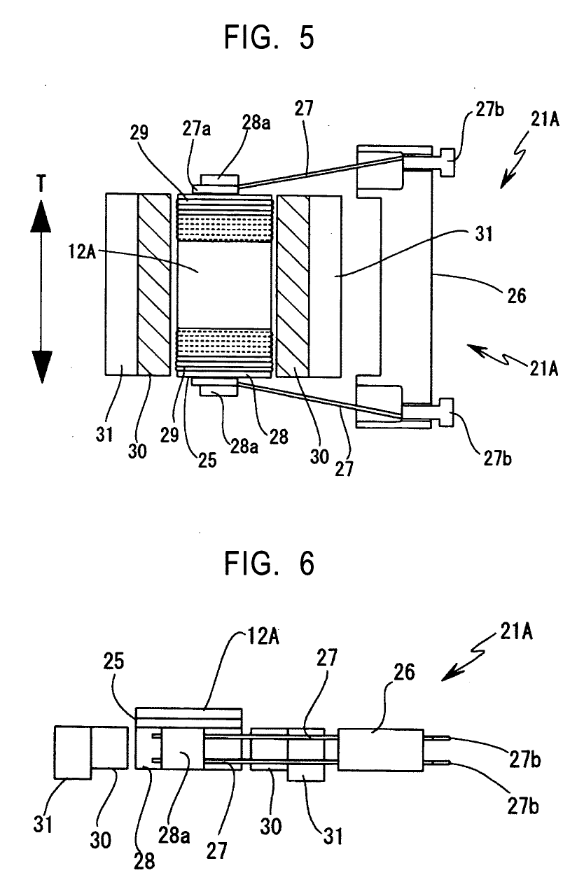

FIGS. 4 to 6 show the structure of a liquid-crystal-mounted uniaxial actuator applied to the above manner (I). FIG. 4 is a perspective view of the uniaxial actuator except for a magnetic field portion, FIG. 5 is a plan view of the uniaxial actuator, as viewed from the direction of the optical axis of an optical system, and FIG. 6 is a side view thereof.

In this example, a uniaxial actuator 21A includes a moving section 25 and a fixed section 26, and the moving section 25 is elastically supported by the fixed section 26 with elastic support members 27 therebetween. While it is preferable that elastic conductive materials, such as leaf springs, be used as the elastic support members 27, wires or the like may be used.

As shown in the figures, the four elastic support members 27 are provided in pairs, and one-end portions 27a thereof are fixed to mounting portions 28a formed on the longitudinal side faces of a bobbin 28 in the moving section 25, and are electrically connected to a liquid crystal element and driving coils which will be described later. The other-end portions of the elastic support members 27 are fixedly placed in receiving recesses formed in the fixed section 26, and are provided with connecting terminals 27b to be connected to unshown circuits (e.g., a driving circuit for the liquid crystal element and a control circuit for the driving coils).

A liquid crystal element 12A is fixedly attached to the bobbin 28 of the moving section 25, and driving coils 29 for driving in the tracking direction are also attached thereto. As shown in FIGS. 5 and 6, a pair of magnets 30 and a pair of yokes 31 are provided. The magnets having opposite polarities oppose each other, and the moving section 25 is positioned therebetween. That is, since a magnetic circuit (open magnetic circuit) in which the magnets 30 are arranged with the polarities (N, S) opposing each other is formed, the moving section 25 can be moved in a direction substantially orthogonal to the direction of the magnetic field produced by the magnets 30 (direction shown by arrow T in the plane of FIG. 5) by passing a current to the driving coils 29 wound in the moving section 25 through the elastic support members 27.

The elastic support members 27 function as members for elastically supporting the moving section 25, and also function as connecting members for establishing an electrical connection to the moving section. Driving signals are transmitted to the driving coils 29 and the liquid crystal element 12A through the members. Since a coil for driving along the optical path (corresponding to a focusing coil in a biaxial actuator for the objective lens) is unnecessary, as described above, the number of signal lines necessary to drive the moving section 25 is reduced.

In the uniaxial actuator, restrictions imposed on the sensitivity of the actuator and the skew value are milder than in the biaxial actuator for driving the objective lens, and therefore, lines other than the elastic support members can be added (in contrast, in the biaxial actuator for driving the objective lens, when a thoughtless addition of lines other than the elastic support members may markedly reduce the sensitivity of the actuator). Since the restriction on the number of signal lines used to drive the liquid crystal element is thereby eased, the laser wavefront can be more precisely controlled in the liquid crystal element by increasing the number of the signal lines for more divisions.

While the magnetic circuit is an open magnetic circuit in which the magnets are arranged with their polarities opposing each other in the illustrated example, various manners may be adopted, for example, a closed magnetic circuit may be formed by providing a back yoke.

While the uniaxial actuator for driving only the liquid crystal elements that forms the aberration correcting device adopts a voice coil motor using the coils and the magnets in the example, as described above, it may adopt a piezoelectric element or the like.

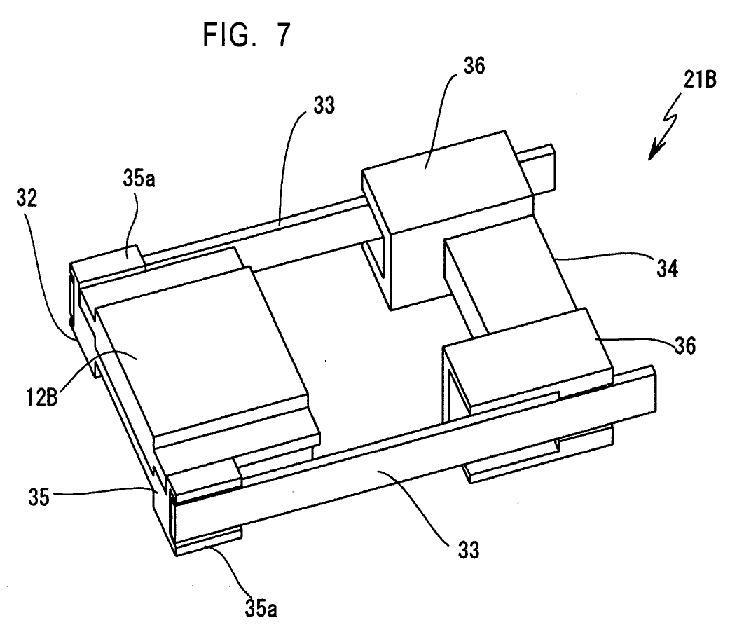

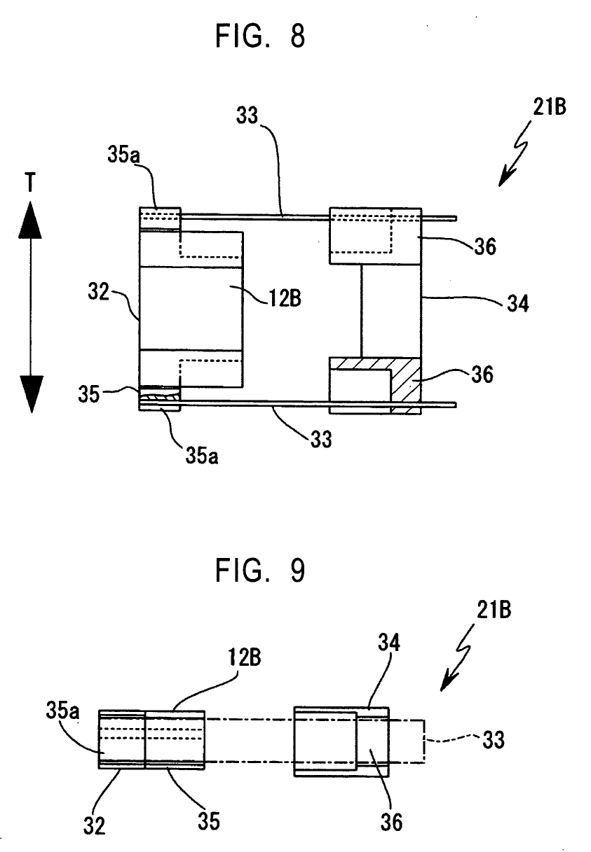

FIGS. 7 to 9 show the configuration of a uniaxial actuator using bimorph piezoelectric elements. FIG. 7 is a perspective view thereof, FIG. 8 is a (partly cutaway) plan view, as viewed from the direction of the optical axis, and FIG. 9 is a side view (in which the piezoelectric elements are shown by a one-dot chain line).

In a uniaxial actuator 21B, a moving section 32 is supported by a fixed section 34 with platelike bimorph piezoelectric elements 33. That is, the piezoelectric elements 33 are shaped like an elongated rectangular plate, and one-end portions thereof are fixed while being received in recesses of mounting portions 35a formed on side faces of a bobbin 35 in the moving section 32. Portions of the piezoelectric elements 33 close to the other-end portions are fixed while being fitted in mounting portions 36 provided in the fixed section 34. By applying a desired potential from an unshown driving circuit to the piezoelectric elements 33, the moving section 32 including a liquid crystal element 12B can be moved in the tracking direction (see arrow T in FIG. 8) relative to a neutral state in which the piezoelectric elements 33 are parallel to each other.

The liquid crystal element 12B can be driven by attaching, to side faces of the platelike piezoelectric elements 33, lines through which a driving signal is supplied to the liquid crystal element 12B.

Since the restrictions on the sensitivity of the actuator and the skew value are also milder in this example than in the biaxial actuator for driving the objective lens, lines can be added outside the routes along the piezoelectric elements. Consequently, since the restriction on the number of signal lines used to drive the liquid crystal element is thereby eased, the laser wavefront can be more precisely controlled in the liquid crystal element by increasing the number of the signal lines for more divisions.

While the piezoelectric elements may be not only of a bimorph type, but also of other types, it is preferable to use bimorph elements, from the standpoints of the moving range, the weight of the moving section, and so on.

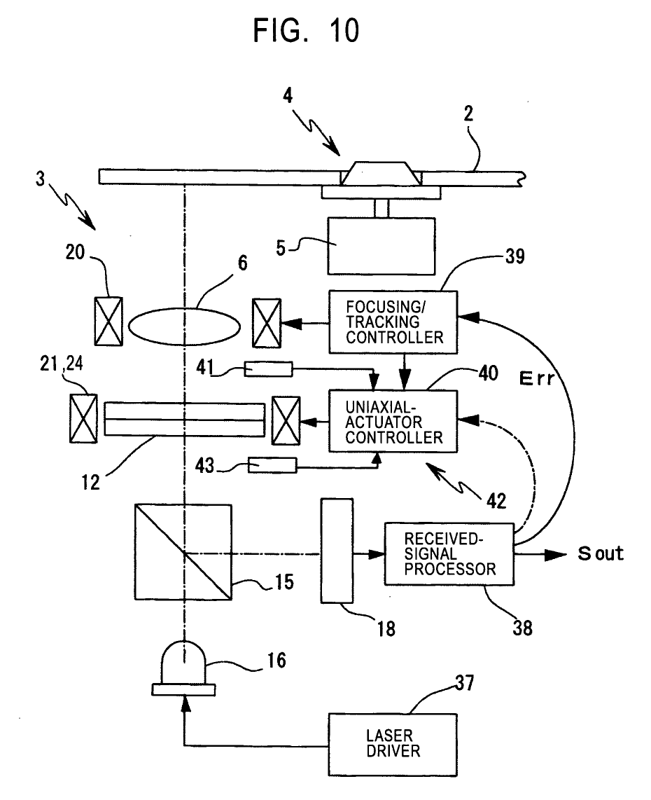

FIG. 10 schematically shows a control system of the optical head in the above-described manner (I) or (II). An optical system is simplified by using a single lens as an objective lens 6 that is driven by a biaxial actuator 20 and showing only a liquid crystal element 12, a polarizing beam splitter 15, a light source 16, and a light receiving section 18.

A semiconductor laser that forms the light source 16 is driven in response to a signal from a laser driver. 37, and light emitted therefrom is detected by the light receiving section 18 after being reflected by a recording layer of a recording medium 2, as described above. A signal representing recording information is fetched as “Sout” from signals processed by a received-signal processor 38. An error signal “Err” for use in focus servo control and tracking serve control is transmitted to a focusing/tracking controller 39. Consequently, a moving section of the biaxial actuator 20 is driven by a driving current supplied from the controller to coils (focusing and tracking coils) in the actuator.

A uniaxial-actuator controller 40 serves to control the driving of a uniaxial actuator 21 (or 24). That is, the uniaxial-actuator controller 40 is needed to cause the liquid crystal element 12 to follow the shift in the tracking direction of the objective lens 6 that is driven by the biaxial actuator 20 under the control of the focusing/tracking controller 39. While a driving signal for the liquid crystal element 12 to be driven by the uniaxial actuator is supplied from an unshown liquid crystal driving circuit, both the uniaxial actuator and the liquid crystal element may be controlled by incorporating the driving circuit in the uniaxial-actuator controller 40.

In any case, in order that the liquid crystal element 12 can move in the tracking direction to follow the movement of the objective lens 6 in that direction, it is necessary to constantly grasp the position of the objective lens or of the moving section including the lens. For that purpose, the following manners may be adopted:

(A) A manner in which the shift of the moving section is detected by a sensor provided in the biaxial actuator.

(B) A manner in which the shift of the moving section is detected on the basis of a driving current to the tracking coils provided in the moving section of the biaxial actuator.

First, in the manner (A), when the moving section of the biaxial actuator 20 shifts in the tracking direction, the shift is sensed and detected by a position detecting means (shift sensor) 41 mounted in the biaxial actuator. That is, a detection signal from the position detecting means 41 is transmitted to the uniaxial-actuator controller 40.

In the manner (B), when the moving section of the biaxial actuator 20 shifts in the tracking direction, the shift is detected on the basis of a change (shift) of a driving current to the tracking coils. That is, the current can be constantly grasped as a driving current supplied from the focusing/tracking controller 39 to the tracking coils. Accordingly, by monitoring the change by the uniaxial-actuator controller 40, the direction and degree of the shift of the moving section of the biaxial actuator 20 can be grasped.

In any manner, the uniaxial-actuator 40 functions as a correcting means 42 that corrects the misalignment between the objective lens and the aberration correcting device.

While the driving of the biaxial actuator 20 is controlled by closed-loop control in which a feedback system is formed based on a servo error signal, as is well known, the driving of the uniaxial actuator may be controlled by open-loop control or closed-loop control. For example, the uniaxial actuator may be driven so that the position of the liquid crystal element is aligned according to the detection result of the position of the objective lens. Alternatively, an error signal (only a tracking error signal) may be transmitted from the received-signal processor 38 to the uniaxial-actuator controller 40 so that the uniaxial actuator is driven, according to the signal, in the direction and by the amount that reduce the misalignment between the objective lens and the liquid crystal element. However, closed-loop control is preferable in order to sufficiently reduce coma aberration due to the misalignment between the objective lens and the liquid crystal element, as described above.

A sensor (shift sensor) is provided as a position detecting means 43 for the uniaxial actuator to detect the shift in the tracking direction of the liquid crystal element 12 to be driven by the uniaxial actuator, and a detection signal therefrom is transmitted to the uniaxial-actuator controller 40. The position detecting means 43 constitutes the correcting means 42 with the uniaxial-actuator controller 40.

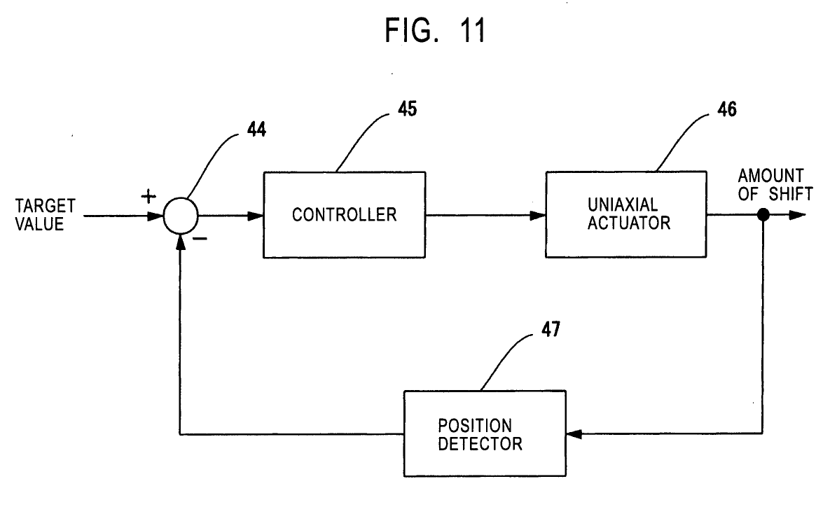

FIG. 11 shows the configuration of the principal part of a servo control system for the uniaxial-actuator controller 40.

A target value (or a directive value) is transmitted to a comparator 44 to be compared with a detection signal from a position detector 47 (including the position detecting means 43), and a signal indicating an error therebetween is transmitted to a controller (control section) 45. The “target value” refers to the amount of relative misalignment (amount of misalignment in the tracking direction) between the moving section of the biaxial actuator for driving the objective lens 6, and the moving section of the uniaxial actuator for driving the liquid crystal element 12. Normal control is exerted while the target value is set at zero, that is, so that the optical centers of the objective lens and the liquid crystal element (aberration correcting device) coincide with each other. That is, since an actual amount of misalignment between the objective lens and the liquid crystal element is detected by the position detector 47, and is fed back to the comparator 44, servo control is exerted so that the amount of misalignment becomes zero. The target value may be intentionally set at an arbitrary value other than zero. For example, by setting the target value at a value necessary to correct a fixed coma aberration, a desired control (skew servo control) is possible, and this is effective for aberration correction.

The controller 45 generates a driving signal for the elements (e.g., the driving coils and the piezoelectric elements) that constitute the driving means for the uniaxial actuator 46, and transmits, to the uniaxial actuator 46 (e.g., 21 or 24), a driving signal in accordance with the level of the error signal from the comparator 44.

By driving the uniaxial actuator 46, the moving section is moved in the tracking direction, information about the amount of the shift is detected by the position detector 47, and is returned to the comparator 44, as described above, so that a feedback control system is formed. Control is exerted so that an error in the comparator 44 (difference between the target value and an actual value) becomes zero (that is, the objective lens and the liquid crystal element are aligned). While only the position control is shown in the figure for simplicity, it is, of course, possible to exert servo control including speed control and acceleration control.

In order to correct only spherical aberration, in the configuration shown in FIG. 11, the target value is set at zero, and control is exerted so that the optical centers of the objective lens and the aberration correcting device are aligned. The position of the objective lens can be detected by a position sensor placed adjacent to the lens, or on the basis of a driving current to the biaxial actuator. Similarly, the position of the aberration correcting device is detected on the basis of a detected value from a position sensor placed adjacent to the device or a driving current to the uniaxial actuator. Alternatively, servo control may be exerted to minimize aberration (e.g., coma aberration) on the basis of a detection signal from an optical detection means positively provided to optically detect the aberration.

While the above-described methods using the driving current and the optical detection means may be adopted to correct aberrations including coma aberration, it may be impossible to achieve sufficient precision, controllability, and the like. That is, since the positions of the moving sections of the actuators must be precisely detected (sensing precision is high) to correct aberrations including not only of spherical aberration, but also of coma aberration, the manner in which position sensors (position detecting means) are provided for the respective moving sections is preferable to the above manner using the driving current. In this case, spherical aberration and coma aberration can be properly corrected by using, for example, a method in which a target control value is calculated by measuring the skew of a disk with an external skew sensor, or a method in which a target control value is calculated by an optical detecting means for optically detecting coma aberration.

In the application to the above manner (II), for example, in the configuration shown in FIGS. 4 to 6 or FIGS. 7 to 9, the liquid crystal element may be replaced with an integrated optical device including a liquid crystal element, optical elements, a light emitting element, a photoreceptor, and so on. In a case in which discrete optical components constitute an optical system, it is preferable to use a feeding mechanism using a ball screw, an electromagnetic actuator, or the like, in consideration of the weight of the moving section. That is, since the moving section includes more optical-system components than when only the aberration correcting device is driven, a moving mechanism using a voice coil motor or a feed screw that produces a greater driving force than in the manner (I) should be used as the uniaxial actuator (second driving means) for driving the moving section. This mechanism itself is not greatly different from a mechanism that conveys an optical head (or pickup) over the inner and outer peripheries of a disk-shaped recording medium. Therefore, by reducing the size of the section excluding the objective lens by integration or the like, the entire section can be caused to follow the movement of the objective lens. Moreover, this manner is more advantageous than the manner (I) in terms of the number of components, cost, and so on, because a driving component only for the liquid crystal element is unnecessary.

In this case, when the moving section of the biaxial actuator in which the objective lens is mounted shifts in the tracking direction, the shift is sensed and detected by the shift sensor provided in the biaxial actuator, or is detected according to a change in driving current to the tracking coil, and the entire moving section including the liquid crystal element is driven by the uniaxial actuator. This allows the moving section to follow the position shift of (the moving section including) the objective lens. That is, in FIG. 11, the uniaxial actuator 46 is replaced with the uniaxial actuator 24, and the amount of displacement between the moving section including the liquid crystal element and the moving section including the objective lens is detected by the position detector 47.

The above-described configuration provides the following various advantages:

Multilayer optical recording can be achieved by reducing aberration due to misalignment between the objective lens and the liquid crystal element (aberration correcting means). For example, the configuration is suitably applied to phase change disks using a blue laser (e.g., DVRs).

The liquid crystal element for correcting spherical aberration is provided separately from the moving section including the objective lens, and the element or the moving section including the element is driven. Since the weight of the moving section of the optical head including the objective lens can be thereby reduced, a sufficient actuator sensitivity of the moving section can be ensured. In addition, it is possible to increase the number of driving signals (or number of signal lines) for the liquid crystal section in the liquid crystal element, compared with the structure in which both the objective lens and the liquid crystal element are mounted in the moving section, and to thereby achieve more precise aberration correction.

### Industrial Applicability

Since the present invention adopts the configuration in which the objective lens and the aberration correcting device are independently driven, the weight of the moving section including the objective lens is reduced. This makes it possible to increase the sensitivity of the actuator and to ensure a necessary number of driving signal lines in the aberration correcting device.

Since the optical centers of the objective lens and the aberration correcting device can be aligned by detecting the amount of misalignment therebetween in the direction orthogonal to the optical axis of the optical system, coma aberration due to the misalignment can be reduced.

Moreover, it is possible to simplify the structure of the driving means for driving only the aberration correcting device.

Since the entire moving section including the aberration correcting device and the components of the optical system is driven, a driving means only for the aberration correcting device is unnecessary, and the degree of flexibility in design can be increased.

Furthermore, since the aberration correcting device is disposed on the parallel optical path and is driven in the direction perpendicular to the optical axis, the configuration is simplified, and easy control is possible.

1. An optical head comprising an objective lens, and an aberration correcting device for an optical system including the objective lens, the optical head further comprising:
first driving means for driving the objective lens; and
second driving means for driving the aberration correcting device, or a moving section including the aberration correcting device and a component of the optical system to correct misalignment between the objective lens and the aberration correcting device,
wherein the aberration correcting device is disposed on the optical path of the optical system.

2. An optical head according to claim 1, wherein the amount of misalignment between the position of the objective lens in a direction orthogonal to the optical axis of the optical system and the position of the aberration correcting device in the direction is detected, and the aberration correcting device or the moving section including the aberration correcting device is driven by the second driving means so that the amount of the misalignment reaches zero or is minimized.

3. An optical head according to claim 2, wherein the misalignment between the objective lens and the aberration correcting device is corrected by driving the aberration correcting device or the moving section including the aberration correcting device by the second driving means in the direction orthogonal to the optical axis of the optical system to follow the movement of the objective lens in the direction.

4. An optical head according to claim 1, wherein the second driving means includes a voice coil motor or a piezoelectric element for driving only the aberration correcting device.

5. An optical head according to claim 1, wherein the second driving means includes a transfer mechanism using a voice coil motor or a feed screw for driving the moving section including the aberration correcting device and the component of the optical system.

6. An optical head according to claim 1, wherein the aberration correcting device is disposed on the optical path of parallel light obtained by collimating light from a light source, and is driven in a direction orthogonal to the optical axis.

7. A disk drive having an optical head comprising an objective lens to be driven while opposing a disk-shaped recording medium, and an aberration correcting device for an optical system including the objective lens, the disk drive comprising:
first driving means for driving the objective lens;
second driving means for driving the aberration correcting device disposed on the optical path of the optical system, or a moving section including the aberration correcting device and a component of the optical system; and
correction means for correcting misalignment between the objective lens and the aberration correcting device.

8. A disk drive according to claim 7, wherein the correction means detects the amount of misalignment between the position of the objective lens in a direction orthogonal to the optical axis of the optical system and the position of the aberration correcting device in the direction, and controls the second driving means so that the amount of the misalignment reaches zero or is minimized.

9. A disk drive according to claim 8, wherein the correction means corrects the misalignment between the objective lens and the aberration correcting device by controlling the second driving means to follow the movement of the objective lens in the direction orthogonal to the optical axis of the optical system.

10. A disk drive according to claim 7, wherein the second driving means includes a voice coil motor or a piezoelectric element for driving only the aberration correcting device.

11. A disk drive according to claim 7, wherein the second driving means includes a transfer mechanism using a voice coil motor or a feed screw for driving the moving section including the aberration correcting device and the component of the optical system.

12. A disk drive according to claim 7, wherein the aberration correcting device is disposed on the optical path of parallel light obtained by collimating light from a light source, and is driven in a direction orthogonal to the optical axis.
